(19) United States
(12) Patent Application Publication
(10) Pub. No.: US 2012/0262395 A1
(43) Pub. Date: Oct. 18, 2012

(54) METHOD OF UPDATING BASELINE OUTPUT VALUES OF TOUCH PANEL

(75) Inventor: CHIEN YU CHAN, Hsinchu City (TW)

(73) Assignee: RAYDIUM SEMICONDUCTOR CORPORATION, HSINCHU (TW)

(21) Appl. No.: 13/443,425

(22) Filed: Apr. 10, 2012

(30) Foreign Application Priority Data
Apr. 12, 2011 (TW) 100112578

(51) Int. Cl. G06F 3/041

(52) U.S. Cl. 345/173

(57) ABSTRACT

An updating method for baseline output values of a touch-sensing panel is disclosed. The touch-sensing panel includes a plurality of X-directional lines and a plurality of Y-directional lines. The X-directional lines and Y-directional lines are arranged intersecting one another so as to form a sensing grid with a plurality of sensing nodes. The method includes the following steps: performing a first scan when the touch-sensing panel is not touched so as to obtain a plurality of first baseline output values; performing a second scan after the touch-sensing panel is touched so as to obtain plurality of touch output values; and updating the baseline output values on the sensing nodes based on a threshold, the first baseline output values and the touch output values.

### BACKGROUND

1. Technical Field

The present invention relates to a method of updating baseline output values of a touch-sensing panel.

2. Related Art

Recently, touch-sensing panels have been widely applied in the fields of home appliance products, communication devices, and electronic information devices, among others. Touch-sensing panels are usually applied as input interfaces of consumer electronics, such as personal digital assistants (PDA), game consoles, etc. The recent trend of integrating a touch-sensing panel with a display screen allows a user to use a finger or a stylus to select an icon displayed on the panel, and the PDA, electronic product or game console executes the indicated function. This type of touch-sensing panel may also be applied in a public information query system, allowing the public to operate the system more efficiently.

FIG. 1 is a schematic diagram illustrating a prior art touch-sensing panel 10. The touch-sensing panel 10 includes a plurality of X-directional lines X₁ to X_{M} and a plurality of Y-directional lines Y₁ to Y_{N,} wherein M and N are different positive integers or the same positive integer. The X-directional lines X₁ to X_{M} and the Y-directional lines Y₁ to Y_{N} are buried in different layers of the touch-sensing panel 10. Referring to FIG. 1, the X-directional lines X₁ to X_{M} and the Y-directional lines Y₁ to Y_{N} are arranged intersecting one another so as to form a sensing grid. In the sensing grid, a sensing node 12 exists at each intersection of X-directional lines and Y-directional lines, and a parasitic mutual capacitance C_{M} is formed between each X-directional line and each Y-directional line. In addition, each X-directional line and each Y-directional line respectively have a line capacitance connected to ground (not illustrated).

In order to provide a consistent response to the same touch amount, a correction process can be performed during the boot-up period of the touch-sensing panel 10. The steps of the correction process involve scanning the whole touch-sensing panel 10 to obtain a baseline output value. The baseline output value represents a voltage of all the sensing nodes when the touch-sensing panel 10 is not touched. After the touch-sensing panel 10 is in normal operation, output values of all the sensing nodes are compared with the baseline output value. When the output value of one of the sensing node is greater than a sum of the baseline output value and a predetermined threshold, the sensing node is deemed a touch node, and a touched position of the sensing node is reported to a controller (not illustrated) for subsequent processing.

However, in the prior art correction process, when a conductor, such as a finger part of a human body, is in contact with a position “A” of the touch-sensing panel 10, through the coupling effect of mutual capacitance C_{M}, different induced voltages will be generated on conductive lines in the proximity of the position “A”. Moreover, when the touch-sensing panel 10 is under a deformed condition, or when the touch-sensing panel 10 is under a different environment temperature, the baseline output value of the touch-sensing panel 10 may exhibit a different result during scanning, affecting subsequent determination of the touch-sensing position.

Therefore, there is a significant need to provide a method for dynamically updating baseline output values of the touch-sensing panel.

### SUMMARY

The present invention is directed to a method of updating baseline output values of a touch-sensing panel. The touch-sensing panel includes a plurality of first-directional lines and a plurality of second-directional lines. The first-directional lines and second-directional lines are arranged intersecting one another so as to form a sensing grid with a plurality of sensing nodes.

According to an embodiment of the present invention, the method includes the following steps: performing a first scan when the touch-sensing panel is not touched, so as to obtain a plurality of first baseline output values on the sensing nodes; performing a second scan after the touch-sensing panel is touched, so as to obtain a plurality of touch output values on the sensing nodes; and updating the baseline output values on the sensing nodes based on a threshold, the first baseline output values, and the touch output values.

According to another embodiment of the present invention, the method includes the following steps: performing a first scan when the touch-sensing panel is not touched, so as to obtain a plurality of first baseline output values on the sensing nodes; performing a second scan after the touch-sensing panel is touched, so as to obtain a plurality of touch output values on the sensing nodes; determining a touch node of the touch-sensing panel based on the baseline output values and the touch output values; and updating the baseline output values based on the touch node.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon reference to the accompanying drawings in which:

FIG. 1 is a schematic diagram illustrating a prior art touch-sensing input device;

FIG. 2 is a schematic block diagram illustrating a touch-sensing input device according to an embodiment of the present invention;

FIG. 3 is a flow chart illustrating a method of updating baseline output values of a touch-sensing panel according to an embodiment of the present invention;

FIG. 4A illustrates signal values stored in a storage unit after a first scan;

FIG. 4B illustrates signal values stored in a storage unit after a second scan;

FIG. 4C illustrates baseline output values of sensing nodes on the touch-sensing panel updated according to the aforementioned setting;

FIG. 5 is a flow chart illustrating a method of updating baseline output values of a touch-sensing panel according to another embodiment of the present invention; and

FIG. 6 illustrates baseline output values of sensing nodes on the touch-sensing panel updated according to the aforementioned setting.

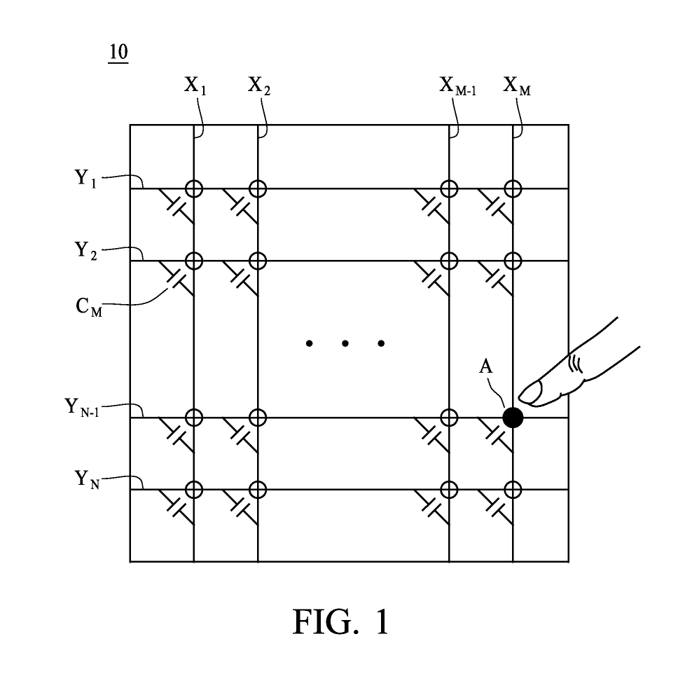

### DESCRIPTION OF THE EMBODIMENTS

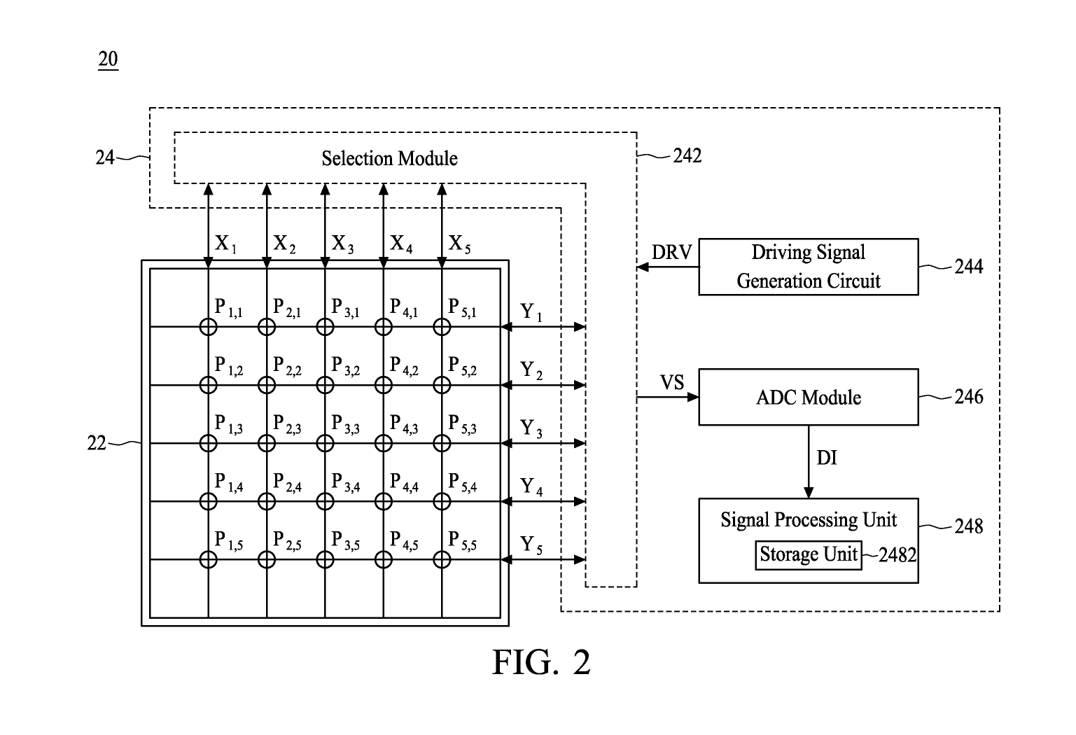

In order to more clearly describe an updating method for baseline output values of a touch-sensing panel according to the present invention, a device performing the method of the present invention is described first as follows. FIG. 2 is a schematic block diagram illustrating a touch-sensing input device 20 according to an embodiment of the present invention. The touch-sensing input device 20 includes a touch-sensing panel 22 and a control device 24. For the purpose of convenience, the touch-sensing panel 22 in FIG. 2 is represented by 5 X-directional lines X₁ to X₅ and 5 Y-directional lines Y₁ to Y₅. The X-directional lines X₁ to X₅ and Y-directional lines Y₁ to Y₅ are buried in different layers of the touch-sensing panel 22, wherein the X-directional lines X₁ to X₅ and the Y-directional lines Y₁ to Y₅ are covered and separated by a dielectric material, whereby electric insulation is achieved.

Referring to FIG. 2, the X-directional lines X₁ to X₅ and the Y-directional lines Y₁ to Y₅ are arranged intersecting one another, so as to form a rectangular sensing grid. However, the present invention is not limited to be implemented according to this manner In the rectangular sensing grid, as illustrated in FIG. 2, a sensing node P_{i,j} is formed at each intersection of X-directional lines and Y-directional lines.

Referring to FIG. 2, the control device 24 in the touch-sensing input device 20 includes a selection module 242, a driving signal generation circuit 244, an analog to digital conversion (ADC) module 246 and a signal processing unit 248. The selection module 242 is configured to select at least one scan line and at least one sense line from the X-directional lines X₁ to X₅ and Y-directional lines Y₁ to Y₅. The driving signal generating circuit 244 is configured to generate a driving signal for the scan line selected by the selection module 242. Then, the ADC module 246 is configured to receive a voltage VS at the sensing node on the sense line selected by the selection module 246 and convert the voltage VS to a digital signal DI. The signal process unit 248 performs calculation based on the digital signal DI, whereby coordinates of a sensing node touched by a user are determined.

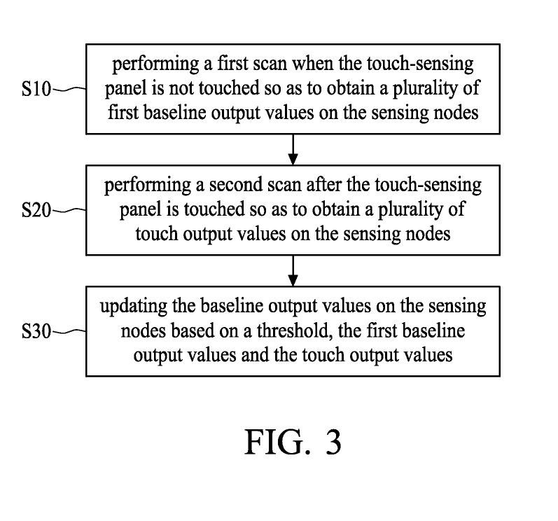

FIG. 3 is a flow chart illustrating a method of updating baseline output values of the touch-sensing panel 22 according to an embodiment of the present invention. The updating method includes the following steps. A first scan is performed when the touch-sensing panel is not touched to obtain a plurality of first baseline output values on the sensing nodes (step S10). A second scan is performed when the touch-sensing panel is touched to obtain a plurality of touch output values on the sensing nodes (step S20). The baseline output values on the sensing nodes are updated based on a threshold, the first baseline output values and the touch output values (step S30). Details of the updating method according to the present invention are provided as follows with reference made to the accompanying drawings.

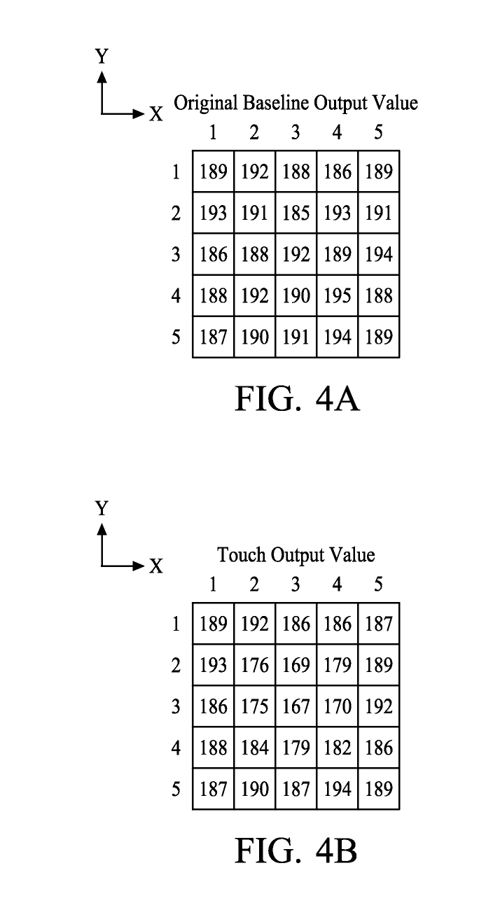

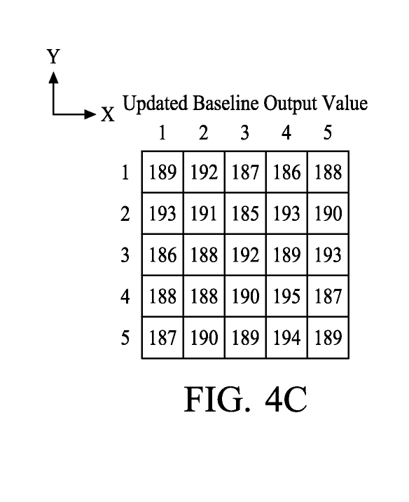

First, the touch-sensing input device 20 performs a first scan when the touch-sensing panel 22 is not touched to obtain a plurality of baseline output values on the sensing nodes P. The performed steps of the scan involve generating driving signals DRV for all the X-directional lines and Y-directional lines in sequence at the driving signal generation circuit 244 of the control device 24. Next, the ADC module 246 of the control device 24 receives a voltage on each sensing node P_{1,1} to P_{5,5} and converts the same to a digital signal. Upon receiving the digital signals, the signal processing unit 248 records the same to a storage unit 2482 for subsequent data comparison to be performed. FIG. 4A illustrates the signal values stored after the first scan in the storage unit 2482. The value in each square in FIG. 4A represents a signal value at each intersection of X-directional lines and Y-directional lines (i.e. each sensing node). For example, the signal value on the sensing node P_{1,1} is “189”, and the signal value on the sensing node P_{3,3} is “192”. These signal values are the baseline output values when the touch-sensing panel 22 is not touched.

Next, the touch-sensing input device 20 performs a second scan when the touch-sensing panel 22 is touched to obtain a plurality of touch output values on the sensing nodes P_{i,j}. The touch output values are recorded in the storage unit 2482 for the subsequent data comparison to be performed. FIG. 4B illustrates the stored signal values after the second scan in the storage unit 2482. Referring to FIG. 4B, the touch output value on the sensing node P₁₁ is “189”, and the touch output value on the sensing node P_{3,3} is “167”. According to the present embodiment, since a change in the output value of the sensing node P_{3,3} is relatively large, the sensing node P_{3,3} may be a touch node.

After the baseline output values and the touch output values on the sensing nodes P_{i,j} are obtained, the signal processing unit 248 performs subtraction to calculate an output difference value on each sensing node P_{i,j}. Then, the signal processing unit 248 updates the baseline output values on the sensing nodes based on a predetermined threshold and the output difference values. For instance, according to the present embodiment, the predetermined threshold is set to be 10. Therefore, if the output difference value on a sensing node is greater than 10, the original baseline output value on the sensing node will be retained as the baseline output value. On the contrary, if the output difference value on a sensing node is smaller than 10, the baseline output value on the sensing node will be updated with a new baseline output value.

The new baseline output value NB can be represented by the following equation:

NB=T×W₁+B×W₂ (1)

W₁+W₂=1 (2)

wherein T is the touch output value on the sensing node and B is the original baseline output value on P_{i,j}, and W₁ and W₂ are weighted indices.

According to an embodiment of the present invention, the weighted indices W₁ and W₂ may be set as fixed values. For example, when the weighted indices are set as 0.5, the new baseline output value NB on the sensing node P_{i,j} is an average of the original baseline output value and the touch output value. FIG. 4C illustrates the updated baseline output values on the touch-sensing panel 22 according to the aforementioned settings. Referring to FIG. 4C, the updated baseline output value of the sensing node will be the original baseline output value or changed to the new baseline output value based on the predetermined threshold. For example, the baseline output value on the sensing node P_{3,3} after update is the original baseline output value “192”, and the baseline output value of the sensing node P_{3,1} after update is the new baseline value “187”.

In another embodiment of the present invention, the weighted indices, W₁ and W₂ may be configured as parameters varying with environment temperature or parameters varying with different positions (such as on the edge or in the center) of the touch-sensing panel, to further correct offsets of the variables.

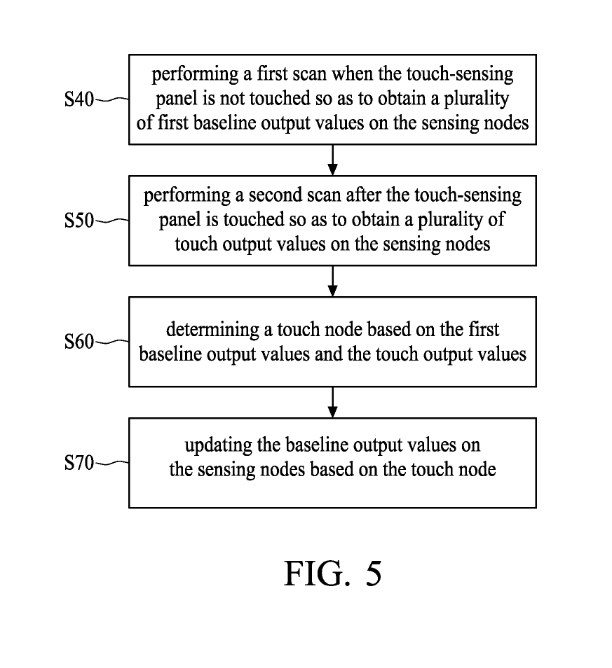

According to yet another embodiment of the present invention, the update of the baseline output value on the sensing node P_{i,j} may be performed based on a touch position. FIG. 5 is a flow chart illustrating the updating method. Referring to FIG. 5, the updating method includes the following steps. A first scan is performed when the touch-sensing panel is not touched to obtain a plurality of baseline output values on the sensing nodes (step S40). A second scan is performed when the touch-sensing panel is touched to obtain a plurality of touch output values on the sensing nodes (step S50). A touch node of the touch-sensing panel is determined based on the baseline output values and the touch output values (step S60) so that the baseline output values on the sensing nodes are updated based on the touch node. Details of the updating method are provided as follows.

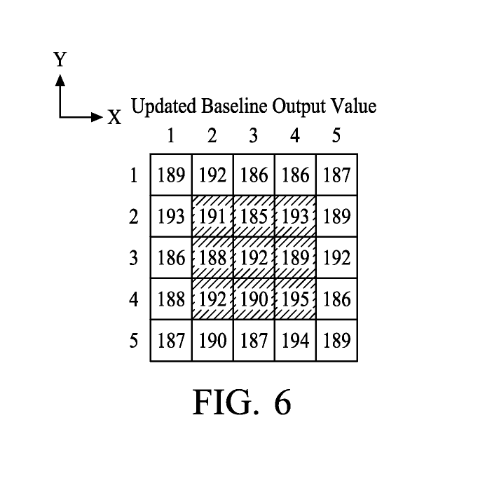

For the operations performed, the signal processing unit 248 first reads the baseline output values (FIG. 4A) and the touch output values (FIG. 4B) stored in the storage unit 2482. Then the signal processing unit 248 performs a subtraction operation on the output values to determine the touch position. Referring to FIG. 4A and FIG. 4B, since the largest difference value of the baseline output values and the touch output values exists on the sensing node P_{3,3}, the signal processing unit 248 sets the sensing node P_{3,3} as a touch node. Next, the signal processing unit 248 configures an update area with the sensing node P_{3,3} being a center. According to the present embodiment, the update area as illustrated by slant lines in FIG. 6 is a 3×3 area. Hence, voltages of the sensing nodes in the update area are maintained to be the original baseline output values, and voltages of the sensing nodes outside the update area are updated with touch output values.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of updating baseline output values of a touch-sensing panel, the touch-sensing panel comprising a plurality of first-directional lines and a plurality of second-directional lines, the first-directional line and second-directional lines arranged intersecting one another, so as to form a sensing grid with a plurality of sensing nodes, the method comprising the steps of:
performing a first scan when the touch-sensing panel is not touched, so as to obtain a plurality of first baseline output values on the sensing nodes;
performing a second scan after the touch-sensing panel is touched, so as to obtain a plurality of touch output values on the sensing nodes; and
updating the baseline output values on the sensing nodes based on a threshold, the first baseline output values, and the touch output values.

2. The updating method according to claim 1, wherein the step of updating the baseline output values of the sensing nodes comprises:
obtaining a difference value by subtracting the touch output value by the first baseline output value on each sensing node;
retaining the first baseline output value as the baseline output value on the sensing node when the difference value is greater than the threshold; and
updating the baseline output value with a second baseline output value when the difference value is smaller than the threshold value.

3. The updating method according to claim 2, wherein the second baseline output value is determined by the first baseline output value, the touch output value and a weighted index on the sensing node.

4. The updating method according to claim 3, wherein the second baseline output value is an average of the first baseline output value and the touch output value.

5. The updating method according to claim 3, wherein the weighted index is a temperature factor.

6. A method of updating baseline output values of a touch-sensing panel, the touch-sensing panel comprising a plurality of first-directional lines and a plurality of second-directional lines, the first directional-lines and second-directional lines arranged intersecting one another, so as to form a sensing grid with a plurality of sensing nodes, the method comprising the steps of:
performing a first scan when the touch-sensing panel is not touched, so as to obtain a plurality of first baseline output values on the sensing nodes;
performing a second scan after the touch-sensing panel is touched, so as to obtain a plurality of touch output values on the sensing nodes;
determining a touch node of the touch-sensing panel based on the baseline output values and the touch output values; and
updating the baseline output values based on the touch node.

7. The updating method according to claim 6, wherein the step of determining the touch node of the touch-sensing panel comprises:
obtaining the largest voltage difference value by subtracting the touch output values by the baseline output values; and
determining one of the sensing nodes to be the touch node based on the largest voltage difference value.

8. The updating method according to claim 7, wherein the step of updating the output values on the sensing nodes based on the touch node comprises steps of:
selecting a plurality of first nodes from the sensing nodes with the touch node being a center;
retaining the baseline output values as the voltages on the first nodes; and
updating the voltages of the nodes other than the first nodes with the touch output values.
